(19) United States
(12) Patent Application Publication
(10) Pub. No.: US 2026/0056019 A1
(43) Pub. Date: Feb. 26, 2026

(54) COMPUTER-BASED DETERMINATION OF TYPES OF FUEL TO USE ALONG A ROUTE

(71) Applicant: International Business Machines Corporation, Armonk, NY (US)

(72) Inventors: Rahul Roy, Kolkata (IN); Siddhartha Sood, Ghaziabad (IN); Jaydeep Sarkar, Kolkata (IN); Krishna Koley, Kolkata (IN); Abhishek Jain, Baraut (IN); Debasis Bhadra, Kolkata (IN); Brati Sankar Ghosh, Kolkata (IN)

(21) Appl. No.: 18/810,289

(22) Filed: Aug. 20, 2024

(51) Int. Cl. G01C 21/20

(52) U.S. Cl. CPC G01C 21/20

(57) ABSTRACT

A method, according to one embodiment, includes determining a first route between a source and a destination, dividing the first route into a plurality of segments, and determining, for the segments of the first route, at least two types of fuel usages for at least one transport medium of the first route to use while traversing along the segments of the first route. The method further includes causing the at least one transport medium of the first route to adhere to the determined types of fuel usages traversing along the segments of the first route. A computer program product, according to another embodiment, includes one or more computer-readable storage media, and program instructions stored on the one or more storage media to perform the foregoing method.

### BACKGROUND

The present invention relates to fuel usage, and more specifically, this invention relates to determinations of types of fuel to use along a route.

An ecological balance for Earth is impacted by multiple factors, such as carbon emission, disturbance of ecological balance for species like marine habitat, and others. As carbon dioxide is released into to Earth's atmosphere, a natural greenhouse effect is promoted, thereby causing a rise in global temperature. To control and manage the carbon footprint, transportation manufacturers around the world are adopting green fuel sources like common natural gas, electricity, or methanol-based fuel as an alternative fuel source.

### SUMMARY

A method, according to one embodiment, includes determining a first route between a source and a destination, dividing the first route into a plurality of segments, and determining, for the segments of the first route, at least two types of fuel usages for at least one transport medium of the first route to use while traversing along the segments of the first route. The method further includes causing the at least one transport medium of the first route to adhere to the determined types of fuel usages traversing along the segments of the first route.

A computer program product, according to another embodiment, includes one or more computer-readable storage media, and program instructions stored on the one or more storage media to perform the foregoing method.

A computer system, according to another embodiment, includes a processor set, one or more computer-readable storage media, and program instructions stored on the one or more storage media to cause the processor set to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2A is a flowchart of a method, in accordance with one embodiment of the present invention.

FIG. 2B is a flowchart of sub-operations of an operation of FIG. 2A, in accordance with one embodiment of the present invention.

FIG. 3 is a system architecture, in accordance with one embodiment of the present invention.

FIG. 4 is a flowchart of a method, in accordance with one embodiment of the present invention.

FIG. 5A is a depiction of routes between a source and destination, in accordance with one embodiment of the present invention.

FIGS. 5B-5E is a depiction of tables based on the routes of FIG. 5A, in accordance with several embodiments of the present invention.

FIG. 6 is a flowchart of a method, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for determination of types of fuel usages along a route.

In one general embodiment, a method includes determining a first route between a source and a destination, dividing the first route into a plurality of segments, and determining, for the segments of the first route, at least two types of fuel usages for at least one transport medium of the first route to use while traversing along the segments of the first route. The method further includes causing the at least one transport medium of the first route to adhere to the determined types of fuel usages traversing along the segments of the first route.

In another general embodiment, a computer program product includes one or more computer-readable storage media, and program instructions stored on the one or more storage media to perform the foregoing method.

In another general embodiment, a computer system includes a processor set, one or more computer-readable storage media, and program instructions stored on the one or more storage media to cause the processor set to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as fuel usage determination code of block 150 for determining types of fuel usages for transport mediums to adhere to along segments of a route. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

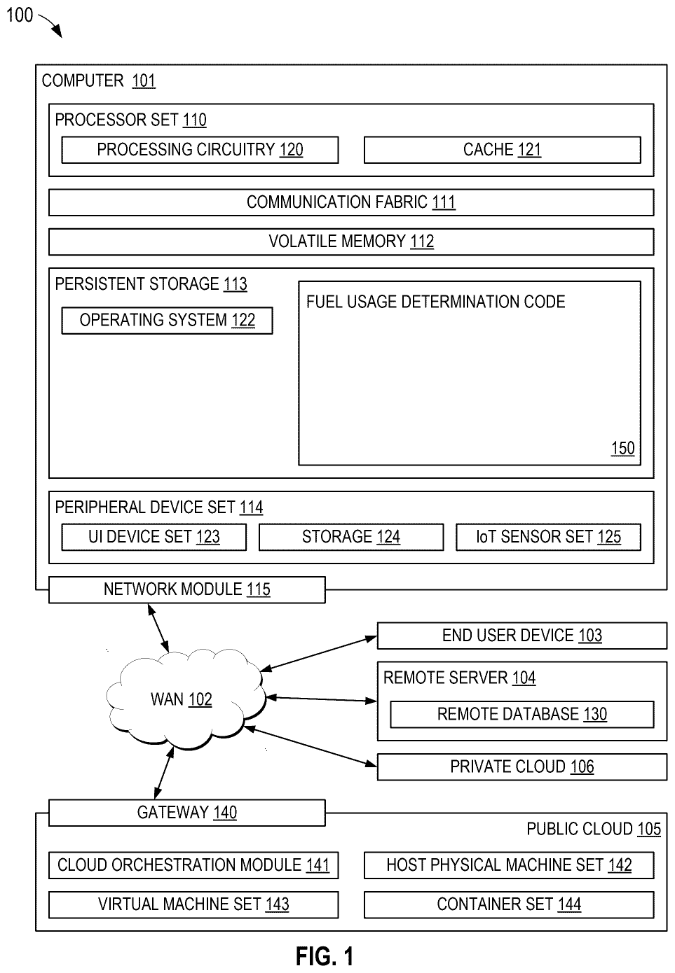

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device.

In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (eud) 103 Is Any Computer System That Is Used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface.

These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere above, an ecological balance for Earth is impacted by multiple factors, such as carbon emission, disturbance of ecological balance for species like marine habitat, and others. As carbon dioxide is released into to Earth's atmosphere, a natural greenhouse effect is promoted, thereby causing a rise in global temperature.

Observations have found carbon dioxide to be responsible for about two-thirds of the total heating influence of all human-produced greenhouse gases. The annual rate of increase in atmospheric carbon dioxide over the past sixty years is about 100 times faster than previous natural increases, such as those that occurred at the end of the last ice age 11,000-17,000 years ago.

Carbon dioxide concentrations increase primarily because of the fossil fuels that humans are burning for energy. Fossil fuels, such as coal and oil, contain carbon that plants extracted from Earth's atmosphere through photosynthesis over many millions of years. In contrast, conventional carbon emissions are returning this carbon to the atmosphere in just a matter of hundreds of years.

While carbon dioxide emission increases, at the same time, the ecological balance of Earth is disturbed by the destruction of animal habitats, e.g., marine hotspots, animal corridors, etc., and others, which is caused, at least in part, by the routes of transport systems like ocean vessels, trucks, etc.

While these transport systems traverse across routes throughout the Earth, carbon dioxide emission is contributed to. Although alternative types of fuel usages have been used to reduce carbon dioxide emission, e.g., such as hybrid vehicles that employ lithium-ion batteries, these alternative types of fuel usages are often not feasible for using across ranges that extend beyond the range of these transport systems, e.g., the range of the transport systems before having to refuel and/or recharge. Accordingly, there is no conventional techniques that determine when, how often, and what parts of a route that alternative types of fuel usages may be used on without relatively significantly slowing travel over the route.

In sharp contrast to the deficiencies described above, the techniques of embodiments and approaches described herein enable reductions to the carbon dioxide emission by causing transport mediums along routes to adhere to determined types of fuel usages while traversing along segments of the routes. More specifically, in order to ensure the reductions to carbon dioxide emissions along a route, the types of fuel usages described above may be determined based on one or more predetermined environmental factors applicable to transport mediums traversing along the segments of the routes.

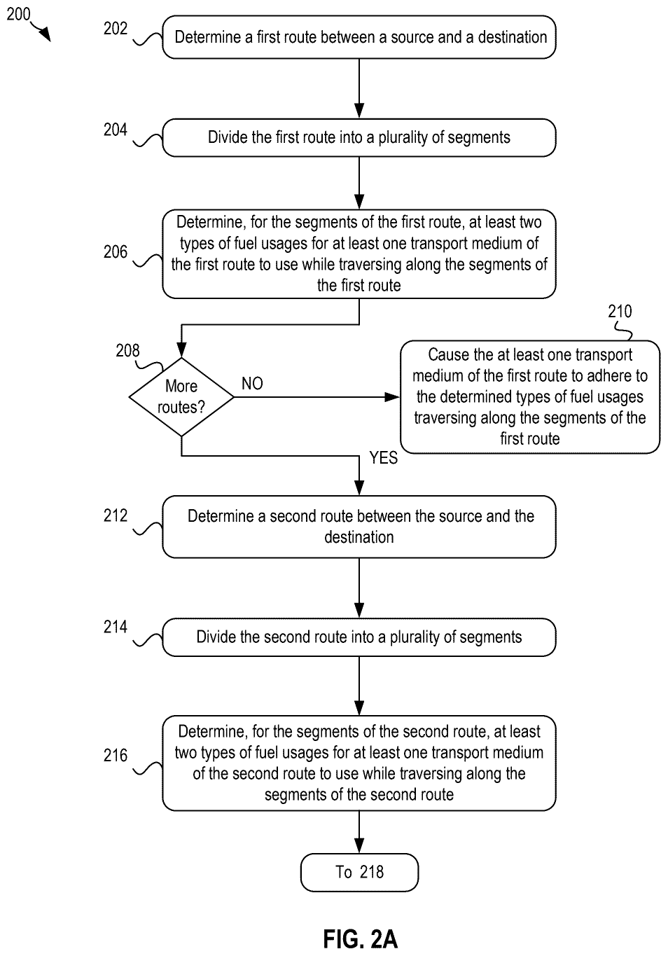

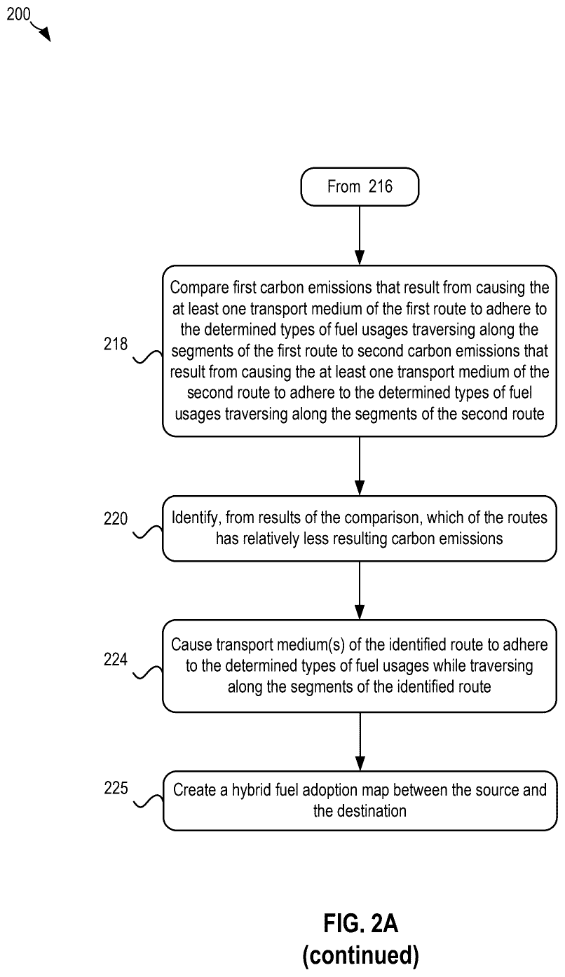

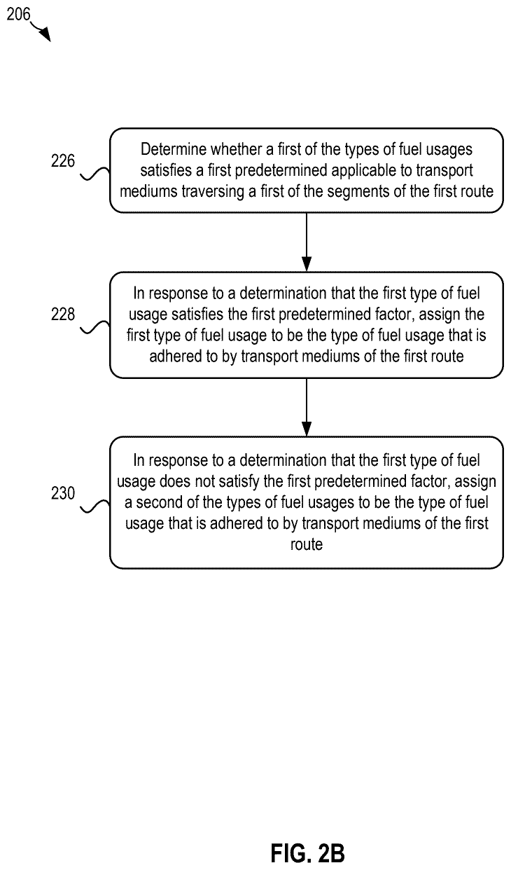

Now referring to FIG. 2A, a flowchart of a method 200 is shown according to one embodiment. The method 200 may be performed in accordance with aspects of the present invention in any of the environments depicted in FIGS. 1-6, among others, in various embodiments. Of course, more or fewer operations than those specifically described in FIG. 2A may be included in method 200, as would be understood by one of skill in the art upon reading the present descriptions.

Each of the steps of the method 200 may be performed by any suitable component of the operating environment. For example, in various embodiments, the method 200 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that, the techniques of embodiments and approaches described herein, e.g., the operations of method 200, may be implemented in environments in which transport mediums traverse between different geographical regions. More specifically, these techniques maybe used in order to determine a route and/or types of fuel usages for transport mediums to use along said route in order to relatively reduce an extent of carbon dioxide emissions being released into Earth's atmosphere. In some approaches, the operations described herein may be performed by a processing circuit that may act as a service and/or be configured to control transport mediums traversing between different geographical regions, e.g., logically control, physically control, instruct, etc. In some other approaches, the operations described herein may be performed by a controller that physically resides on one of said transport mediums.

For context, the transport mediums described herein may be machines and/or physical components that are configured to use one or more types of fuel to travel along a route. For example, in some approaches, the transport mediums may include a car, a truck, a plane, a boat, a drone, a train, etc. It may be prefaced that, in approaches described herein, the types of fuel used by the transport mediums to travel along a route may include a first type of fuel usage that, as a result of being used, causes the emission of relatively more carbon dioxide into Earth's atmosphere than a second type of fuel usage. For example, in some preferred approaches, the first type of fuel usage uses a petroleum-based internal combustion engine fuel, while the second type of fuel usage may use compressed natural gas. The second type of fuel usage may additionally and/or alternatively include electricity from lithium ion batteries, liquefied natural gas, hydrogen fuel cells, etc.

Operation 202 includes determining a first route between a source and a destination. In some approaches, the first route may be identified from a request that is received, e.g., from at least one transport medium that is scheduled to travel from the source to the destination. The first route may include different geographical portions that are traveled along to depart from the source to reach the destination. For example, in some approaches, these geographical portions may span across air, highways, currents in one or more bodies of water, paths, bodies of water, land masses, bridges, etc. Furthermore, the source of the first route may, in some approaches, be a starting point from which a first transport medium departs in order to begin travel to the destination. The destination may be an end of the route. In one use case example, the source is a current location of a product that is scheduled to be delivered to the destination, and the destination may be a consumer that ordered the product.

Determining a route between a source and a destination may, in some approaches, include connecting a plurality of different segments of the route together, where each of the segments may include, e.g., roads, airways, navigable waterways, etc., that the transport mediums can travel along. In some other approaches, determining the route between the source and the destination may additionally and/or alternatively include outputting indications of the source and destination to a mapping service and/or hardware component that is configured to determine and return one or more routes that are currently usable between the source and description, e.g., thereby the first route is obtained.

The first route may be divided into a plurality of segments, e.g., see operation 204. In some approaches, the route may be divided into a plurality of segments by identifying different types of route mediums, e.g., highways, roads, airways, etc., that will be traveled along during a traversal of the first route, and segmenting the route into portions based on the different route mediums. The first route may be additionally and/or alternatively divided into a plurality of segments based on at least one predetermined factor, e.g., such as factors that govern the transport mediums while traveling along the first route. For example, in some approaches, the predetermined factor may be based on whether a portion of the route is an ecologically endangered zone, e.g., a geographical area that includes a habitat of species that are relatively more sensitive to carbon emissions and/or temperatures associated with carbon emissions and/or pollution associated with emissions of transport mediums. In another example, in some other approaches, the predetermined factor may additionally and/or alternatively be based on whether a portion of the route is a high emission zone. For context, a high emission zone may, in some approaches, be defined as a geographical area that already has and/or has historically had relatively higher carbon emissions present therewithin. These high emission zones may be subject to governing emission standards, in some approaches, and therefore, the route may be divided according to different standards, e.g., in order to ensure that the standards are adhered to.

Additional predetermined factors, by which the first route may be divided based on, may, in some approaches, include, e.g., cost of refuel along the first route, types of fuel available along the route for refueling a transport medium, tolls that transport mediums are subject to along the route, historical areas of relatively greater traffic congestion, historical areas of relatively greater traffic collisions, areas in which endangered animal species are present (e.g., within a predetermined proximity of a predetermined geographical location), forecasted weather types, etc.

Operation 206 includes determining, for the segments of the first route, at least two types of fuel usages for at least one transport medium of the first route to use while traversing along the segments of the first route. For context, traversal along the segments of the first route (while using the at least two types of fuel usages) may be made in accordance with at least one transport medium that travels along one or more of the segments of the first route. In other words, in some approaches the transport mediums collectively traverse the first route in a relay-style fashion. For example, in some approaches, traversal of the first route may be performed by the transport mediums in order to transport a good and/or person from the source to the destination, e.g., where the good and/or person transitions between the transport mediums in relay-style fashion along the segments of the first route. In contrast, in some other approaches, operation 206 may additionally and/or alternatively include determining, for the segments of the first route, at least two types of fuel usages for at least one transport medium of the first route to use while traversing along the segments of the first route. It should be noted that such an operation may be performed, in some approaches, with respect to a single transport medium. For example, in some approaches, a transport medium may be configured to selectively switch types if fuel usages while traveling along different segments of a route, e.g., alternate between an internal combustion engine and energy from a lithium ion battery. Accordingly, although operations of various approaches herein are described to be performed with respect to transport mediums, in some approaches, these operations may additionally and/or alternatively be performed with respect to a single transport medium on one or more of the routes.

Looking to FIG. 2B, exemplary sub-operations of determining types of fuel usages for transport mediums to use while traversing along the segments of the route are illustrated in accordance with one embodiment, one or more of which may be used to perform operation 206 of FIG. 2A. However, it should be noted that the sub-operations of FIG. 2B are illustrated in accordance with one embodiment which is in no way intended to limit the invention.

In some approaches, in order to determine types of fuel usages for transport mediums to use while traversing along the segments of the first route, a query may be performed to determine vendors that offer fuel resupply services along the segments of the first route. In some other approaches, in order to determine types of fuel usages for transport mediums to use while traversing along the segments of the first route, a query may be performed to governing bodies and/or municipal codes of the first route to determine types of transport mediums and/or types of fuel usage that are authorized to traverse the segments of the first route.

Sub-operation 226 of FIG. 2A includes determining whether a first of the types of fuel usages, e.g., the types of fuel usages determined from one or more of the queries described above, satisfies a first predetermined environmental factor applicable to transport mediums traversing a first of the segments of the first route. Note that although a first of the segments of the first route is considered in the sub-operations of FIG. 2B, in some other approaches, other segments of the first route may be additionally and/or alternatively be considered using similar operational techniques. In some approaches, the predetermined first factor may include cost, e.g., a cost of using the type of fuel usage for the first segment of the first route to transport a good and/or person. In some other approaches, the predetermined first factor may additionally and/or alternatively include carbon present in the first segment. Considering carbon present in the first segment allows for predetermined carbon thresholds to not be exceeded. For example, in the analysis of operation 206, in order to predetermined carbon thresholds to not be exceeded, types of fuel usage associated with causing relatively lesser carbon dioxide emissions may be selected for using over types of fuel usage associated with causing relatively greater carbon dioxide emissions. In some other approaches, the predetermined first factor may additionally and/or alternatively include whether the first segment is an ecological endangered zone and/or whether endangered animal species are present along (e.g., within a predetermined proximity of) the first segment.

In response to a determination that the first type of fuel usage satisfies the first predetermined factor, the first type of fuel usage is assigned to be the type of fuel usage that is adhered to by transport mediums of the first route, e.g., see sub-operation 228. Of course, in some approaches, a plurality of considered types of fuel usage may be determined to satisfy the first predetermined factor. In one or more of such approaches, a collection of types of fuel usage may be determined and compared with one another, e.g., compared with respect to one or more of the predetermined factors. This way, one of the types of fuel usage having relatively least carbon dioxide emissions may be selected for use. However, in some approaches, each of the different predetermined factor may be assigned different weightages for this comparison. This way, in some approaches, a first of the types of fuel usage having relatively more carbon dioxide emissions may be selected for use over a second of the types of fuel usage having relatively less carbon dioxide emissions based on the first type of fuel usage being determined to be associated with relatively less costs (where a cost factor is assigned relatively greater weight in the comparison than a carbon dioxide emission factor).

In contrast, in some approaches, in response to a determination that the first type of fuel usage does not satisfy the first predetermined factor, a second of the types of fuel usages is assigned to be the type of fuel usage that is adhered to by transport mediums of the first route, e.g., see sub-operation 230. In some approaches, the second type of fuel usage is assigned to be the type of fuel usage in response to a determination that the second type of fuel usage satisfies the first predetermined factor. In other words, in some approaches, in response to a determination that the first type of fuel usage does not satisfy the first predetermined factor, additional types of fuel usage may be considered.

Several approaches and embodiments described herein refer to different types of fuel usages. In some preferred approaches, the first type of fuel usage uses a petroleum-based internal combustion engine fuel. Furthermore, in some of these approaches, the first type of fuel usage may be a type of fuel usage that is associated with relatively greater carbon dioxide emissions than the second type of fuel usage as a direct result of being consumed by a transport medium. The second type of fuel usage, in some preferred approaches, may include one or more of, e.g., electricity from lithium ion batteries, compressed natural gas, liquefied natural gas, hydrogen fuel cells, etc.

Referring back to FIG. 2A, decision 208 includes optionally determining whether more routes exist between the source and the destination. For context, in some approaches, only one route exists between the source and destination. In some other approaches, more than one route exists between the source and destination, and therefore, a determination may be made as to whether use of a second route over use of a first route would result in relatively more efficiencies, e.g., relatively less carbon dioxide emissions, relatively less costs, relatively less travel time, etc. In response to a determination that more routes between the source and the destination do not exist, e.g., as illustrated by the “NO” logical path of decision 208, method 200 includes causing the transport mediums of the first route to adhere to the determined types of fuel usages traversing along the segments of the first route, e.g., see operation 210.

Causing the transport mediums of the first route to adhere to the determined types of fuel usages traversing along the segments of the first route, in some approaches, includes penalizing and/or disabling transport mediums that do not adhere to the determined types of fuel usages while traversing along the segments of the first route. In order to penalize such transport mediums, in some approaches, in response to a determination that a first of the transport mediums of the first route does not adhere to a first of the determined types of fuel usages while traversing along a first of the segments of the first route, a penalty point is assigned to the first transport medium of the first route. These penalty points may be recorded and tracked in a table that is monitored and used to determine whether to disable a transport medium, e.g., in response to a determination that an assigned penalty point threshold is exceeded. In some approaches, an indication of the assignment of the penalty point is output to a predetermined governing body, e.g., a governing body that controls traffic of transport mediums along one or more segments of the first route.

Referring again to decision 208, in response to a determination that more routes (other than the first route) are available, e.g., as illustrated by the “YES” logical path of decision 208, method 200 includes determining at least a second route between the source and the destination, e.g., see operation 212. The second route may be divided into a plurality of segments, e.g., see operation 214. Techniques for dividing the first route into a plurality of segments may be modified and used for dividing the second route into a plurality of segments. Operation 216 includes determining, for the segments of the second route, at least two types of fuel usages for at least one transport medium of the second route to use while traversing along the segments of the second route.

Operation 218 includes comparing first carbon emissions that result from causing the transport mediums of the first route to adhere to the determined types of fuel usages traversing along the segments of the first route to second carbon emissions that result from causing the transport mediums of the second route to adhere to the determined types of fuel usages traversing along the segments of the second route. The carbon emissions are, in some approaches, determined and/or calculated based on historical data that is obtained from current and/or previous traversals of the transport mediums on the first route and/or other routes determined to have at least a predetermined degree of similarity with the first route. For example, this information may include, e.g., geographic information system (GIS) data, geofencing library data, historical carbon emission data, readouts from sensors on the transport mediums, etc.

Operation 220 includes identifying, from results of the comparison, which of the routes has relatively less resulting carbon emissions. It should be noted that, although the comparison is described to be performed with respect to carbon dioxide emissions, the comparison and/or operations performed based on the comparison may additionally and/or alternatively be performed with respect to other predetermined factors, e.g., cost whether the first segment is an ecological endangered zone, etc.

Operation 224 includes causing transport mediums of the identified route to adhere to the determined types of fuel usages while traversing along the segments of the identified route. In some approaches, causing transport mediums of the identified route to adhere to the determined types of fuel usages while traversing along the segments of the identified route includes causing, e.g., instructing transport mediums, a product to be transported from the source to the destination along the identified route, where the transport mediums of the identified route are caused to adhere to the determined types of fuel usages while traversing along the segments of the identified route to transport the product from the source to the destination. As described elsewhere above, in some approaches, this adherence may be caused by physically controlling the transport mediums. Additional techniques for causing this adherence are described below.

In some approaches in which penalty points are used to cause the transport mediums of the first route to adhere to the determined types of fuel usages traversing along the segments of the first route, method 200 may include determining whether a sum of penalty points assigned to the first transport medium of the first route exceeds a predetermined penalty point threshold. Unique predetermined penalty point thresholds may be assigned to different transport mediums. This way, the unique threshold assigned to a transport medium that has historically failed to adhere to the determined types of fuel usages may be lowered to enforce relatively stricter adherences before the transport medium is disabled. In response to a determination that the sum of penalty points assigned to one of the transport medium, e.g., the first transport medium, of the first route exceeds the predetermined penalty point threshold, corrective action may optionally be performed. In some approaches, performance of the corrective action may include determining a second route between the source and the destination, and dividing the second route into a plurality of segments. The corrective action may additionally and/or alternatively include determining for the segments of the second route, at least two types of fuel usages for transport mediums of the second route to use while traversing along the segments of the second route, and causing a product to be transported from the source to the destination along the second route. The transport mediums of the second route adhere, e.g., as a result of being instructed and/or controlled, to the determined types of fuel usages for transport mediums of the second route while transporting the product along the segments of the second route. In contrast to the determination described above, in response to a determination that the sum of penalty points assigned to the first transport medium of the first route does not exceed the predetermined penalty point threshold, method 200 may include causing the product to be transported from the source to the destination along the first route.

In some approaches, a graphical map (hereafter referred to as a “hybrid fuel adoption map”) that illustrates the comparisons and determinations described herein may be generated for displaying on a graphical user interface (GUI), e.g., see operation 225. In some approaches, in order to generate the hybrid fuel adoption map data may be obtained. The obtained data, in some approaches, includes geographic information system (GIS) data about different routes and/or transport mediums, geofencing library data, historical carbon emission data, etc. The obtained data may be used to create the hybrid fuel adoption map between the source and the destination. The hybrid fuel adoption map, in some approaches, details a plurality of routes between the source and the destination including the first route. To distinguish different information in the hybrid fuel adoption map, the hybrid fuel adoption map may visually indicate the determined types of fuel usages of the routes, e.g., color visual coding the different types of fuel usages, visually depicting the numerical carbon emission thresholds, color patterning a breakdown of the segments of different routes, etc.

Various benefits are enabled within the technical field of routing and transportation as a result of the techniques described herein. This is because although use of alternative fuel sources as a single source of energy may be relevant in relatively short distance haul transport mediums, e.g., small and light vehicles, vessels, barges and railways, for relatively long haul journeys (along a route of a distance in which the average transport medium needs refueling) in which transport mediums including airplanes, ocean vessels, and/or long haul trucks are used, fuel infrastructure is not mature enough to enable an alternative fuel source as the only source of fuel. Accordingly, the techniques described herein enable the use of hybrid fuel infrastructure where transport mediums can use a plurality of different determined types of fuel usage types along a route. These techniques have not been enabled within conventional technologies, as evident by Earth's rising temperature. Because these novel techniques measure the fuel usage at an individual transportation system level and for an aggregated eco-system of connected transportation systems, the techniques thereby provide dynamic and adaptive recommendations on how the hybrid fuel implementations can be used to mitigate carbon emissions into Earth's atmosphere. Within the shipping industry, the techniques described herein directly mitigate marine life disturbances and imbalances on ocean shipping routes. Similar benefits are enabled along segments of a route that exist in the air and segments of a route located on land.

It should also be noted that the operations of embodiments and approaches described herein, e.g., see method 200, may be may be performed by an AI model that is trained using a predetermined training set of data. For example, in some approaches, various of the operations noted above may be deployed in a trained state of a trained AI model. Training of the AI model, in some approaches, may be performed by applying a predetermined training data set to learn how to determine types of fuel usages for transport mediums to adhere to along segments of a route and/or cause the adherence. Initial training may include reward feedback that may, in some approaches, be implemented using a subject matter expert (SME). However, to prevent costs associated with relying on manual actions of a SME, and more practically to enable global deployment of the techniques described herein for reducing carbon emissions around the world, in another approach, reward feedback may be implemented using techniques for training a BERT model, as would become apparent to one skilled in the art after reading the present disclosure. Once a determination is made that the AI model achieves a redeemed threshold of accuracy of performing the operations described herein during this training, a decision that the model is trained and ready to deploy for performing techniques and/or operations of method 200 may be performed. In some further approaches, the AI model may be a neuromyotonic AI model that may improve performance of computer devices in an infrastructure associated with global navigation and travel, because the neuromyotonic AI model may not need an SME and/or iteratively applied training with reward feedback in order to accurately perform operations described herein. Instead, the neuromyotonic AI model is configured to itself make determinations described in operations herein. Weight values may, in some approaches, be used by the AI reasoning model to collect and analyze information and/or feedback potentially received from transportation systems described herein. Again, such an AI model ensures that the carbon emissions experienced herein are able to be experienced on a global scale, where the scale of such analysis and determinations would not otherwise be feasible for a human to perform. This is because humans are not able to efficiently readily make such determinations while tracking, in real time, updates to factors that are used to make the determinations described herein, and would otherwise incorporate processing delays and errors in the determination of types of fuel usage in the process of attempting to do so. Accordingly, management of operations described herein is not able to be achieved by human manual actions.

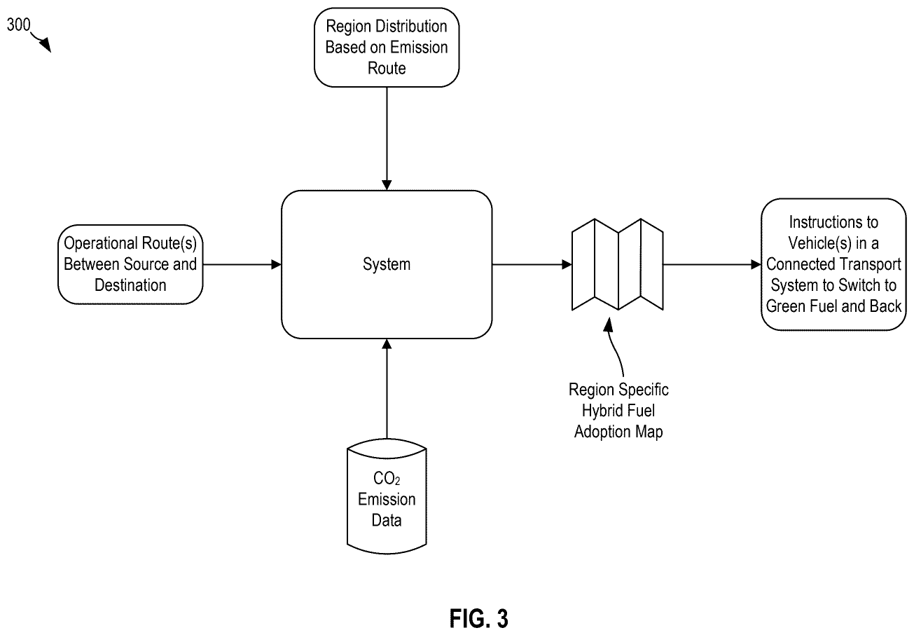

FIG. 3 depicts a system architecture 300, in accordance with one embodiment. As an option, the present system architecture 300 may be implemented in conjunction with features from any other embodiment listed herein, such as those described with reference to the other FIGS. Of course, however, such system architecture 300 and others presented herein may be used in various applications and/or in permutations which may or may not be specifically described in the illustrative embodiments listed herein. Further, the system architecture 300 presented herein may be used in any desired environment.

The system architecture 300 may, in some approaches, be used to determine an answer to two key questions which may help hybrid transportation manufacturers, hybrid transportation service providers as well as environment, social and governance (ESG) control groups to achieve fuel efficiency over a route from a source to a destination. A first of these questions that is answered using the techniques described herein is based on which region of a route is best suited to use relatively cleaner energy green types of fuel as opposed to a first type of fuel that is petroleum based. In order to answer this question, a system of the system architecture 300, e.g., see “System”, that is configured to perform the operations described herein may be used to determine how to break a given route (see “Operational Route(s) Between Source and Destination”) in to a plurality of separate fuel-usage segments. In some approaches, registration of scheduled journeys and progress of current route traversals by transport mediums may be determined from obtained data, e.g., see CO₂ emission data. In some approaches, a collection of transport mediums determined to pass through a particular region at a particular point in time may be grouped together and thereafter be termed as a connected transport system. These groupings may depend on different regions that a route passes through which may be determined from geographical data, e.g., see “Region Distribution Based on Emission Route”.

A hybrid fuel adoption map may, in some approaches, be generated and output by the system to guide transport mediums where to use first type of fuel and where to use other types of fuel so as to keep an overall carbon dioxide emission within permissible limits (considering the sum of emission of all the transport mediums within a connected transport system). In some approaches, this overall sum may be referred to as the “aggregated transport system emission”.

The connected transport system enabled by the system may be a configurable group of transport systems, in some approaches. Three use case examples of the composition of the connected transport systems will now be described. In a first use case example, transporters interested in a status of individual/single vehicles may be provided with a defined connected transport system that includes a single vehicle. This connected transport system may be defined by instructions to a transport medium (the single vehicle), e.g., see “Instructions to Vehicle(s) in a Connected Transport System to Switch to Green Fuel and Back”. Maps and reports of the emission of the single vehicle may be generated accordingly, e.g., see “Region Specific Hybrid Fuel Adoption Map”. In a second use case example, enterprises interested in the status of a group of their vehicles may be provided a defined transport system that is based on only the vehicles from the named enterprise. Maps and reports of the aggregate emission of the connected transport system may be generated accordingly. Finally, in a third use case example, regulatory bodies interested in vehicles in a particular geofenced region may be provided in a defined transport system that is based on the vehicles present in the geofenced region. The aggregate emission of the connected transport system may be matched against the threshold of that region and maps and reports can be generated accordingly.

A second of these questions that is answered using the techniques described herein is based on how and when to instruct a hybrid transportation system to switch from a first type of fuel usage to a second type of fuel usage. In order to answer this question, the techniques described herein may, in some approaches, use sensors deployed in the transportation systems and connected to system which consume various input feeds and then load a hybrid fuel adoption map into a sensor to enable both automatic switching between fuel usage types.

A fuel adoption status of the transport systems in the same region may be considered in conjunction with other determinations described herein. A calculation may be performed to determine an aggregated emission for the connected transport system, and the determined aggregated emission may be compared with a recommended emission level of the region. This way, the connected transport system emission is less than the recommended emission level at that region.

In some approaches, there may be a request for one or multiple transport mediums in a connected transport system, due to some special circumstances, to overrule determined types of fuel usages for a given route. Penalty points may be issued to these transport mediums to prevent this. In response to a determination that such special circumstances exist, the dynamic hybrid fuel adoption map may be redrawn for the other transport mediums in the connected transport system. In response to a determination that the other transport mediums adopt an updated map, these transport mediums are preferably awarded reward points, e.g., which may cancel out penalty points. At an end of the route, penalty and credit points may be balanced or translated to predetermined rewards or penalties.

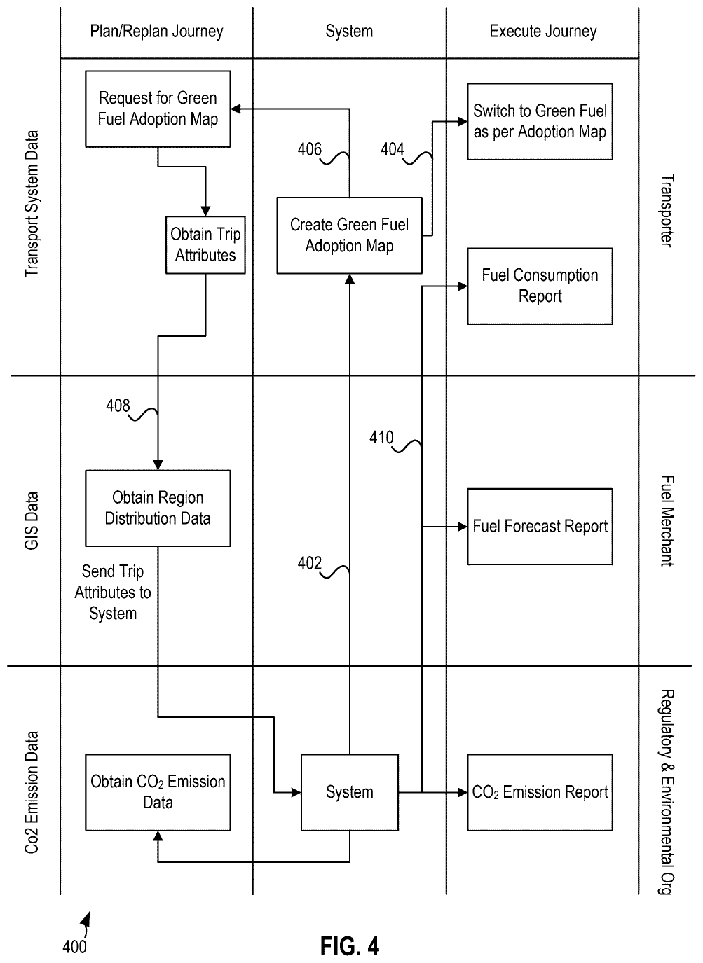

Now referring to FIG. 4, a flowchart of a method 400 is shown according to one embodiment. The method 400 may be performed in accordance with aspects of the present invention in any of the environments depicted in FIGS. 1-6, among others, in various embodiments. Of course, more or fewer operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

It should be noted that FIG. 4 includes infrastructure that may be configured to perform operations of method 400. For example, this infrastructure may include a processing circuit, e.g., see “System”, that is configured to obtain data, process the data, and output instructions based on the data, where the instructions control one or more transport mediums. Furthermore, for context, for any enterprise using long-haul land and/or ocean transportation, the usage of traditional fuel sources is extremely detrimental to the environment, through emission of greenhouse gases. The widescale adoption of using green fuel in transportation like electricity as energy source for land transportation and methanol as an alternative for ocean transportation, has not occurred to combat this issues based on the adoption being extremely expensive. To solve these deficiencies, and thereby mitigate the emissions described above, the system, which may also be referred to as “Intelligent Autonomous Sustainability Control Tower” (IASCT), may perform operations to create a “hybrid fuel adoption” map, e.g., see operation 402, for a plurality of operational route between a source and a destination. The hybrid fuel adoption map may include and/or issue instructions to switch between types of fuel usages, e.g., see operation 404, and may be provided to a transport medium upon a request for the map being received, e.g., see operation 406.

In some approaches, the hybrid fuel adoption map may be dynamically created based on the connected transport system emission of all or some of vehicles registered with IASCT and passing through the region. This system may take one or more operational routes between a source and destination and then mashup historical CO₂ emission data, transport system data and GIS data to create specific “second type of fuel usage” regions between the source and destination. In some approaches, the map may be generated based on predetermined types of obtained data. For example, “region distribution data”, which may be based on obtained trip attributes (vehicle type, goods weight, origin via destination, estimated time of arrival and/or departure, etc.) may be obtained in operation 408. The map may be dynamically created and/or updated based on an aggregated connected transport system emission between a source and destination based on region's emission level and defined threshold. The map may, in some approaches, be dynamically updated, e.g., redefined, based on a single or multiple vehicles being determined to not adhere to the prescribed map, and guide a transportation system to switch on to a determined type of fuel usage based on the generated map.

Outputs of the system may, in some approaches, include recommendations of where to use determined types of fuel usage, e.g., along which segments, so as to ensure that the respective CO₂ emissions of the segments stay under the different approved thresholds. Additional outputs of the system may, in some approaches, include a CO₂ emission report, and a fuel forecast report a fuel consumption report, e.g., see operation 410, to user devices of predetermined destinations, e.g., see Transporter, Fuel Merchant and Regulatory & Environmental Org.

The system and operations of method 400 may be used for planning and/or replanning a journey, fuel forecasting, and furthermore, to generate CO₂ emission reports. While the journey planning may be of interest to transporters, the reports can be useful for transporters, fuel merchants and various regulatory and environment protection organizations, e.g., see Transporter, Fuel Merchant and Regulatory & Environmental Org. Additional operations that may be performed in method 400 to determine types of fuel usages for transport mediums to adhere to along a given route include using Geographic Information System (GIS) and geofencing library data to divide one or more operational routes between source and destination into regions, and processing CO₂ and other greenhouse gas emission data to determine a region's current emission levels.

Method 400 may additionally and/or alternatively include generating alerts, e.g., in response to a determination that a transport medium is not following a determined type of fuel usage (per a respective region), in response to a determination that a transport medium is using the wrong type of fuel usage in a predetermined high emission region or ecologically endangered region, etc. Instructions may also be determined and output that inform the transport mediums where to refuel and/or how much fuel to being a route segment with. Redeterminations may be performed in response to a determination that replanning of a hybrid fuel adoption is required due to multitude of factors, e.g., such as low fuel, change in destination, etc. Method 400 may, in some approaches, include dynamically recommending and onboarding new transportation systems in an ongoing “connected sustainability network” to maximize sustainability gains for a particular geofenced region as part of an ongoing journey.

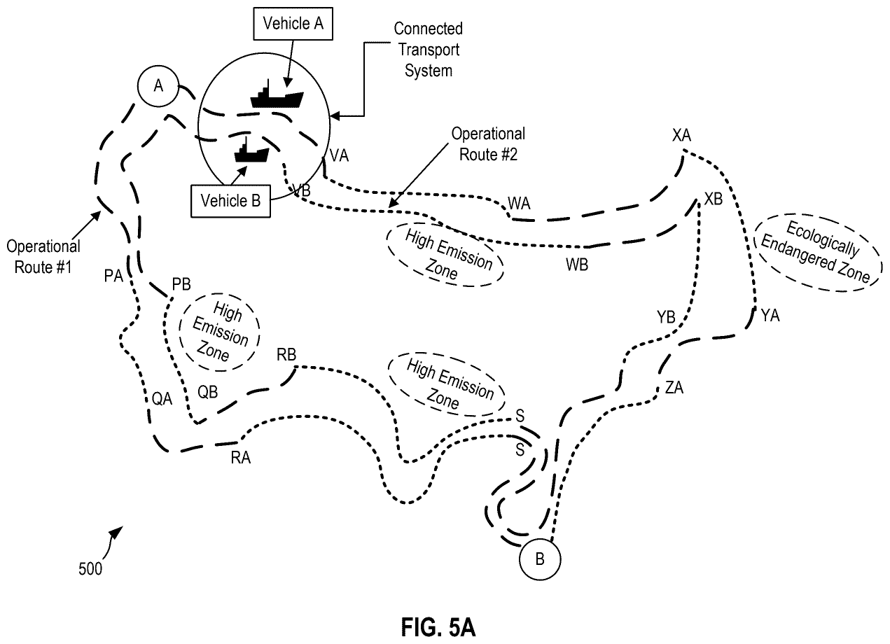

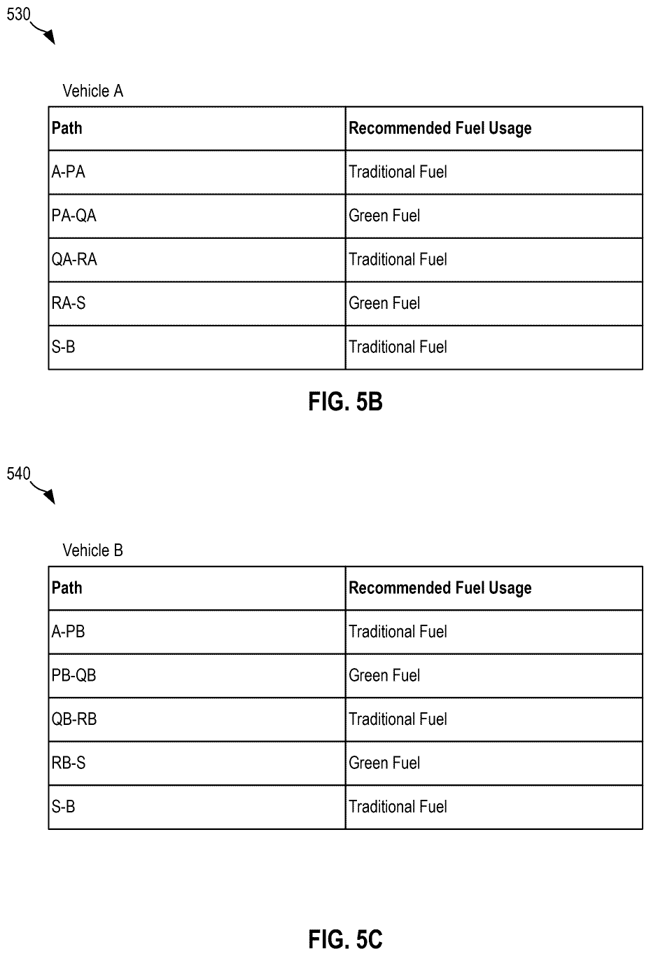

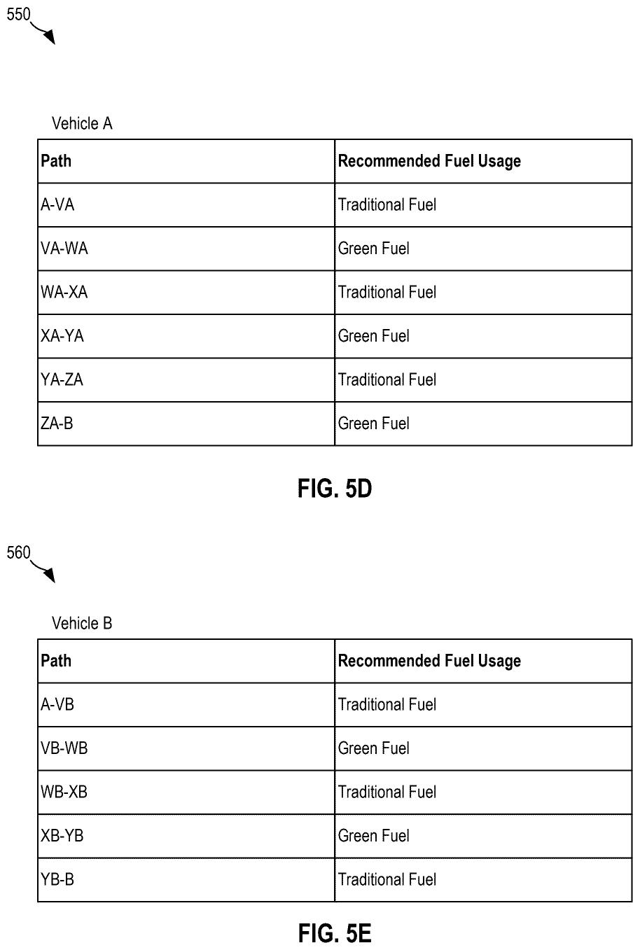

FIG. 5A depict routes 500 between a source and destination and FIGS. 5B-5E depict tables 530, 540, 550 and 560 of information based on segments of the routes of FIG. 5A, in accordance with several embodiments. As an option, the present routes 500 and tables 530, 540, 550 and 560 may be implemented in conjunction with features from any other embodiment listed herein, such as those described with reference to the other FIGS. Of course, however, such routes 500 and tables 530, 540, 550 and 560 and others presented herein may be used in various applications and/or in permutations which may or may not be specifically described in the illustrative embodiments listed herein. Further, the routes 500 and tables 530, 540, 550 and 560 presented herein may be used in any desired environment.

Referring first to FIG. 5A, a plurality of routes, e.g., see operational route #1 and operational route #2, are depicted from a source, e.g., see “A”, and a destination, e.g., see “B”. Each of the routes includes two different breakdowns of determined types of fuel usage, where the different types of fuel usages are divided between different segments of the route. For example, along the first route, a first breakdown includes the segments: source A to point PA, point PA to point QA, point QA to point RA, point RA to point S, and point S to destination B, while a second breakdown includes the segments: source A to point PB, point PB to point QB, point QB to point RB, point RB to point S, and point S to destination B. Furthermore, along the second route, a first breakdown includes the segments: source A to point VA, point VA to point WA, point WA to point XA, point XA to point YA, point YA to point ZA and point ZA to destination B, while a second breakdown includes the segments: source A to point VB, point VB to point WB, point WB to point XB, point XB to point YB, and point YB to destination B.

The segments of the route may be located on land, bodies of water and/or airspace between the source and the destination. Various key influencing factors such as ecological impact, weather predictions, rules, regulations, etc., may be taken into considerations to determined types of fuel usage to use while traversing from the source to the destination, e.g., via connected transport systems that include transport mediums vehicle A and vehicle B. An analysis may be performed to determine which types of fuel usage to use, and operations described herein may be used to perform such analysis. For example, based on obtained near real time carbon emission data points, for each operational route, and for all the vehicles of the connected transport system passing through the region, a determination may be made as to how much of the different regions of respective routes should be traversed using a first type of fuel (referred to as “traditional fuel” in FIGS. 5B-5E) as opposed to a second type of fuel (referred to as “green fuel” in FIGS. 5B-5E).

The analysis and determinations described above ensure that carbon emission footprint in each segment always stay below predetermined stipulated threshold limits, e.g., see ecologically endangered zone and high emission zones, as recommended by regulatory authorities applicable in regions that the respective segments are located. In some approaches, a mapping that includes the routes of FIG. 5A may be generated for each vehicle based on aggregate connected transport system emissions in a particular region. The map may, in some preferred approaches, be updated with near real time inputs from sensors of the each of the vehicles in the connected transport systems and communicated to these vehicles.

Referring now to FIGS. 5B-5C, for operational route #1, the tables 530 and 540 include determined types of fuel usage types for each of the transport mediums vehicle A and vehicle B. These fuel usage types may be determined using techniques described elsewhere herein, e.g., see method 200. Similarly, referring now to FIGS. 5D-5E, for operational route #2, the tables 550 and 560 include determined types of fuel usage types for each of the transport mediums vehicle A and vehicle B. These fuel usage types may be determined using techniques described elsewhere herein, e.g., see method 200.

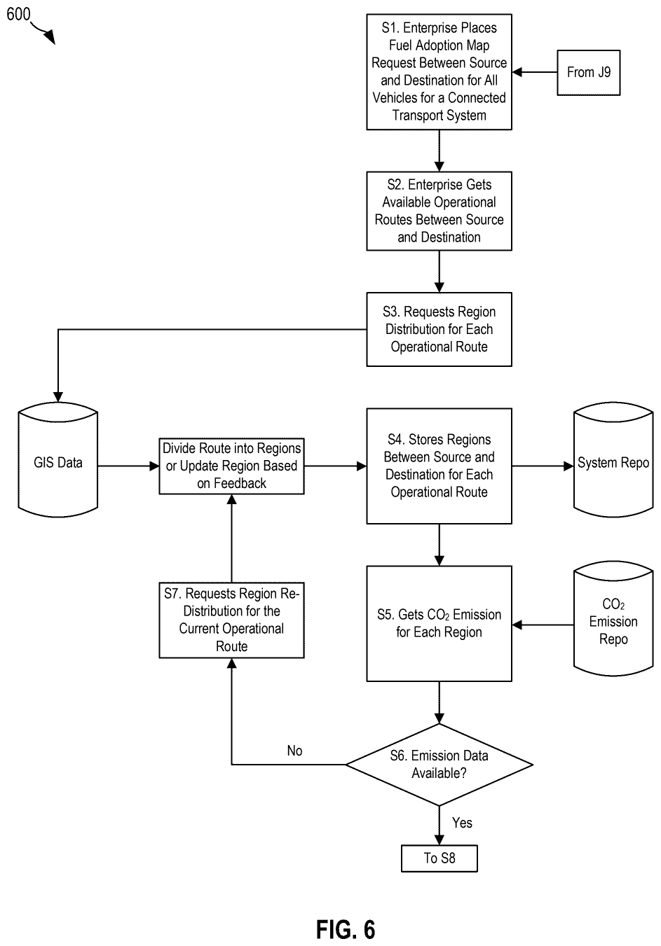

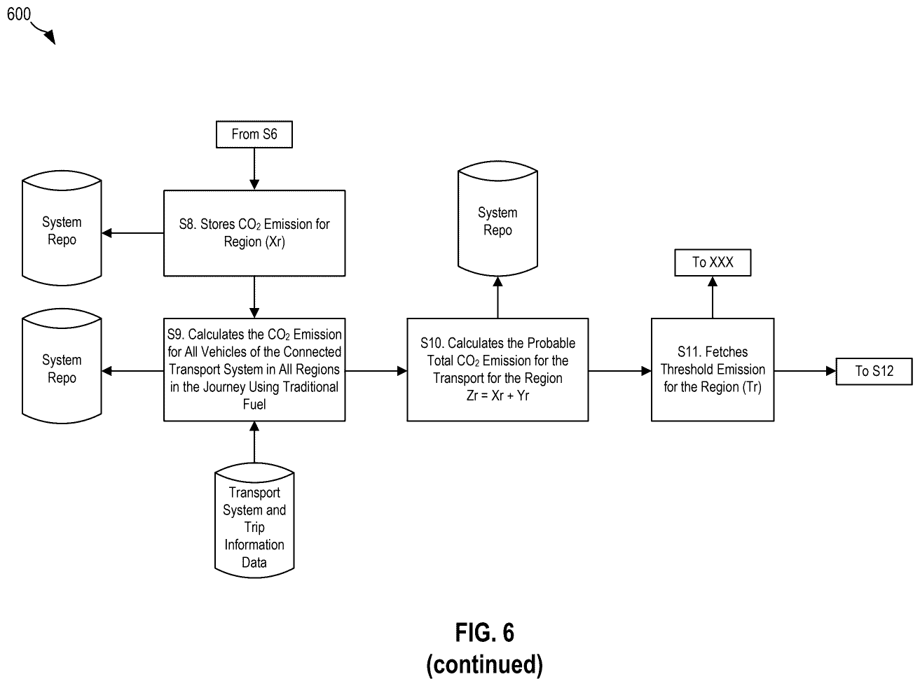

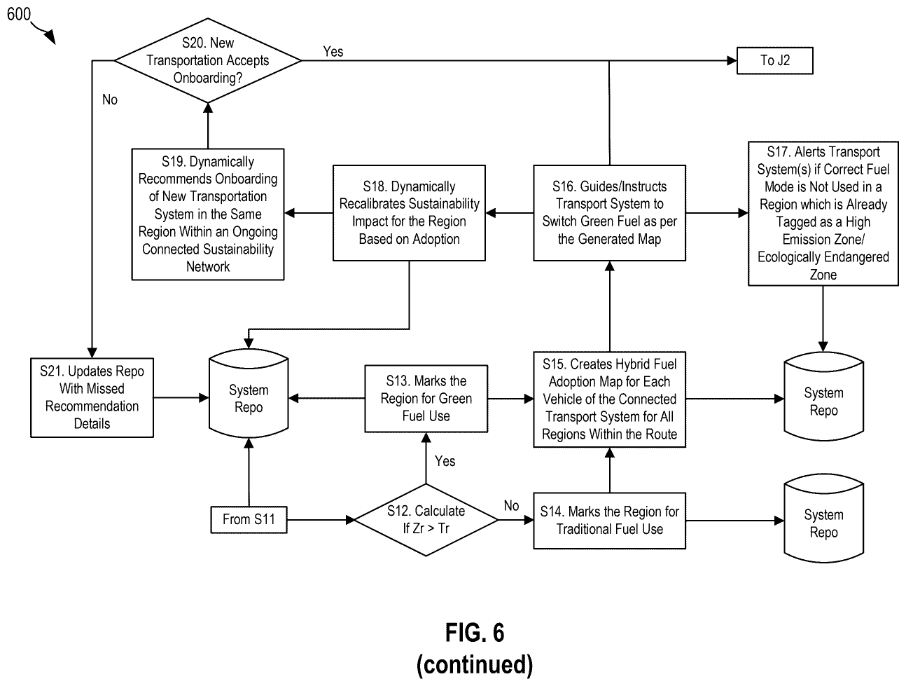

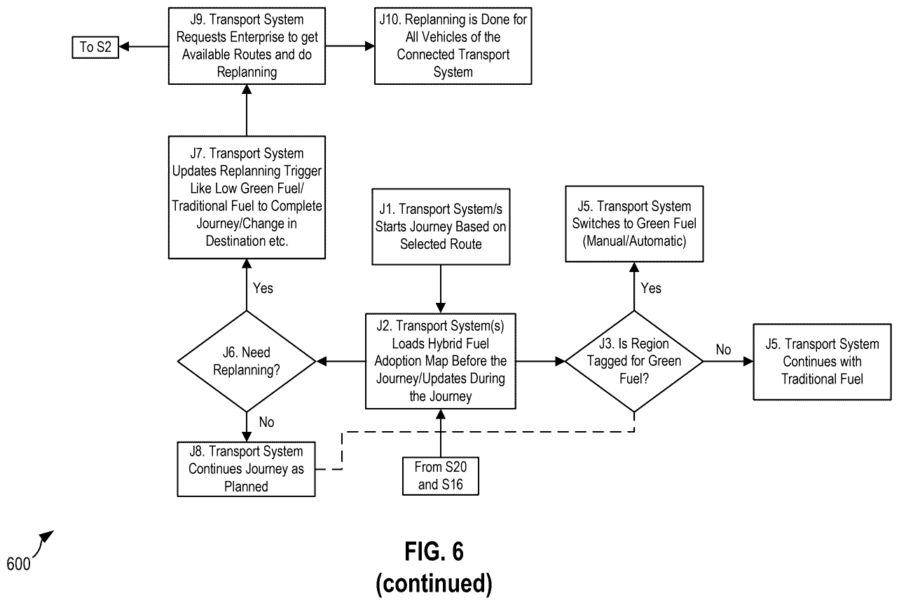

Now referring to FIG. 6, a flowchart of a method 600 is shown according to one embodiment. The method 600 may be performed in accordance with aspects of the present invention in any of the environments depicted in FIGS. 1-6, among others, in various embodiments. Of course, more or fewer operations than those specifically described in FIG. 6 may be included in method 600, as would be understood by one of skill in the art upon reading the present descriptions.

Each of the steps of the method 600 may be performed by any suitable component of the operating environment. For example, in various embodiments, the method 600 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 600. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 600 includes various operations that highlight responsibilities of a processing circuit that may be referred to below as an Intelligent Autonomous Sustainability Control Tower (IASCT). The method 600 focuses on answering key questions including how the IASCT creates a hybrid fuel adoption map for a route and how IASCT will guide and/or instruct transport systems, e.g., transport mediums, to switch between different types of fuel usages in accordance with a determined recommended adoption map.

A list of terms used in the descriptions of method 600 and their definitions is provided below.
CO₂ Emission: Region based CO₂ emission data with a predetermined threshold value. CO₂ emissions may be used to obtain a threshold value and region-specific CO₂ emission value for a comparison. Note that regions are also referred to herein as “segments” of a route.
IASCT: System infrastructure for determining all dynamic data, such as, regions for the route, CO₂ emission for transportation, green fuel indication for regions along a route, etc. The IASCT enables the storage of all dynamic data to create a hybrid fuel adoption map based on aggregated connected transport system emissions.
Geographic Information System (GIS): All geographic location data and groups. This is an external library, filled with all geographical location data and may be used to divide one route into several segments.
Transport System and Trip Information data: Trip related data for the transport medium, which may be used to provide details such as CO₂ emission range for different transport mediums.

In some approaches, the method 600 includes two distinct paths, e.g., a first path (see “S” operations) that describes analysis and determinations before a journey is undertaken by transport mediums along a route. In other words, the first path describes planning the types of fuel usages for a route. A second route (see “J” operations) describes, while on the journey, an execution of a hybrid fuel adoption map guidance or replanning during the journey.

Along the first path, operation S1 includes an enterprise request being placed and/or received for a fuel adaptation map between a source and a destination for a group of transport mediums (vehicles) that will be part of a connected transport system when a journey has started or when planning for a journey. Furthermore, operation S2 includes obtaining all available operational routes between the source and destination. In some approaches, these routes are determined and/or obtained from enterprise data. In operation S3, region distribution between source and destination is requested for each operational route from GIS library data. The region distribution data for each operational route is stored in an IASCT repository, e.g., see operation S4.

Operation S5 includes, for each segment of a route, fetching CO₂ emission data from a CO₂ emission repository. In response to a determination that CO₂ emission data is available for a given region, the method optionally proceeds to operation S8, e.g., see decision S6. In contrast, in response to a determination that no emission data is found for the given segment, the method optionally proceeds to operation S7.

Operation S7 includes sending feedback for a redistribution of region definition between the source and the destination. In operation S8, available CO₂ emission for the region (Xr) is stored in the IASCT repository. Operation S9 includes fetching aggregated CO₂ emission data for the connected transport system of the transport medium from the transport system and trip data repository. Probable CO₂ emission of the region (Yr) during a particular time are also calculated using traditional fuel and stored in the IASCT repository.

Operation S10 includes calculating probable total CO₂ emissions (Zr) for the transportation as a sum Xr and Yr, e.g., Zr=Xr+Yr. A CO₂ emission threshold value is fetched for the region (Tr) from IASCT repository, e.g., see operation S11. In response to a determination that total CO₂ emissions (Zr) are greater than a CO₂ emission threshold value (Tr), the method moves to operation S13, else the method continues to operation S14, e.g., see decision S12. Operation S13 includes marking the region for the green fuel use to minimize CO₂ emissions and storing the region in the IASCT repository.

Operation S14 includes marking a region in the IASCT repository for the traditional fuel use to minimize CO₂ emission. All region-specific data is fetched from the IASCT repository, and a hybrid fuel adaptation map is created for each transport medium for the route, e.g., see operation S15. Method 600 includes optionally repeating and/or performing operations S3-S15 for all applicable operational routes as provided by an enterprise.

Operation S16 includes instructing and/or guiding transportation system(s) to switch to using green fuel as per selections within the hybrid fuel adaptation map. In operation S17, transport system(s) are alerted in response to a determination that a correct fuel mode is not used in a region which is already tagged as a high emission zone and/or ecologically endangered zone. Operation S18 includes dynamically recalibrating sustainability impact for the region based on adoption, as well as changing environmental factors to identify new opportunities to maximize gain or minimize negative impact due to non-adherence. In operation S19, onboarding of new transportation system in the same region within an ongoing connected sustainability network is dynamically recommended to maximize sustainability gains or balance negative impacts. New transportation systems in the region are recommended in S20 to adopt a new hybrid fuel usage map. If accepted, the transportation system proceeds with loading the map as per step J2. Furthermore, in operation S21, in response to a determination that a transportation system rejects a recommendation, details of the missed recommendation are updated in the repository for future training and recommendation generation purposes.

Along the second path, which includes operations based on an interaction of a transport system (of transport mediums) with operations of IASCT mentioned above, operation J1 includes starting a journey based on a selected route. In some approaches, these operations are performed based on instructions provided by the IASCT. In operation J2, the transport system loads the green fuel adoption map (received from S15) at the start of the journey across one or more segments of the route and/or updates during the journey. In operation J3, a transport system checks if that region is tagged for green fuel, and then the system moves to operation J4, else operation J5. In operation J4, the transport system is caused, e.g., instructed, to green fuel (manual/automatic). In operation J5, the transport system continues with traditional fuel. Operation J6 includes the transport system checking whether replanning is required due to various trigger causes, e.g., such as relatively low green fuel/traditional fuel to complete a remainder of the journey and/or whether a destination has changed from what was originally planned. In response to a determination that replanning is required, the transport system updates the enterprise on the replanning need and a replanning criteria, e.g., see operation J7. In response to a determination that no replanning is required, the transport system continues journey as planned and follows path of step J3, e.g., see operation J8. In operation J9, the transport system requests that the enterprise obtain an updated hybrid fuel adoption map based on replanning criteria and follows path of step S2. In operation J10, the replanning is performed for all vehicles in the connected transport system to ensure that the aggregate emission from the system is under control.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
determining a first route between a source and a destination;
dividing the first route into a plurality of segments;
determining, for the plurality of segments of the first route, at least two types of fuel usages for at least one transport medium of the first route to use while traversing along the segments of the first route; and
causing the at least one transport medium of the first route to adhere to the determined types of fuel usages traversing along the segments of the first route.

2. The method of claim 1, wherein the at least one transport medium is selected from the group consisting of: a car, a truck, a plane, a boat, a drone, and a train.

3. The method of claim 1, wherein the determining, for the segments of the first route, at least two types of fuel usages for the at least one transport medium to use while traversing along the segments of the first route comprises:
determining whether a first of the types of fuel usages satisfies a first predetermined factor applicable to transport mediums traversing a first of the segments of the first route;
in response to a determination that the first type of fuel usage satisfies the first predetermined factor, assigning the first type of fuel usage to be the type of fuel usage that is adhered to by transport mediums of the first route; and
in response to a determination that the first type of fuel usage does not satisfy the first predetermined factor, assigning a second of the types of fuel usages to be the type of fuel usage that is adhered to by transport mediums of the first route.

4. The method of claim 3, wherein the predetermined first factor is selected from the group consisting of: cost, carbon present in the first segment, whether the first segment is an ecological endangered zone, and whether endangered animal species are present along the first segment.

5. The method of claim 3, wherein the first type of fuel usage uses a petroleum-based internal combustion engine fuel, wherein the second type of fuel usage uses a fuel selected from the group consisting of: electricity from lithium ion batteries, compressed natural gas, liquefied natural gas, and hydrogen fuel cells.

6. The method of claim 1, further comprising:
determining a second route between the source and the destination;
dividing the second route into a plurality of segments;
determining for the plurality segments of the second route, at least two types of fuel usages for at least one transport medium of the second route to use while traversing along the segments of the second route;
comparing first carbon emissions that result from causing the at least one transport medium of the first route to adhere to the determined types of fuel usages traversing along the segments of the first route to second carbon emissions that result from causing the at least one transport medium of the second route to adhere to the determined types of fuel usages traversing along the segments of the second route;
identifying, from results of the comparison, which of the routes has relatively less resulting carbon emissions; and
causing a product to be transported from the source to the destination along the identified route, wherein the at least one transport medium of the identified route is caused to adhere to the determined types of fuel usages while traversing along the segments of the identified route to transport the product.

7. The method of claim 1, wherein the causing the at least one transport medium of the first route to adhere to the determined types of fuel usages traversing along the segments of the first route comprises:
in response to a determination that a first transport medium, of the at least one transport medium of the first route, does not adhere to a first of the determined types of fuel usages while traversing along a first of the segments of the first route, assigning a penalty point to the first transport medium of the first route, and further comprising:
outputting an indication of the assignment of the penalty point to a predetermined governing body.

8. The method of claim 7, wherein the causing the at least one transport medium of the first route to adhere to the determined types of fuel usages traversing along the segments of the first route comprises:
determining whether a sum of penalty points assigned to the first transport medium of the first route exceeds a predetermined penalty point threshold,
in response to a determination that the sum of penalty points assigned to the first transport medium of the first route exceeds the predetermined penalty point threshold:
determining a second route between the source and the destination;
dividing the second route into a plurality of segments;
determining for the plurality of segments of the second route, at least two types of fuel usages for at least one transport medium of the second route to use while traversing along the segments of the second route; and
causing a product to be transported from the source to the destination along the second route, wherein the at least one transport medium of the second route adheres to the determined types of fuel usages for at least one transport medium of the second route while transporting the product along the segments of the second route, and
in response to a determination that the sum of penalty points assigned to the first transport medium of the first route does not exceed the predetermined penalty point threshold: causing the product to be transported from the source to the destination along the first route.

9. The method of claim 1, further comprising:
obtaining data, the obtained data including data selected from the group consisting of:
geographic information system (GIS) data, geofencing library data, and historical carbon emission data; and
using the obtained data to create a hybrid fuel adoption map between the source and the destination, wherein the hybrid fuel adoption map details a plurality of routes between the source and the destination including the first route, wherein the hybrid fuel adoption map visually indicates the determined types of fuel usages of the routes.

10. A computer program product comprising:
one or more computer-readable storage media; and
program instructions stored on the one or more storage media to perform operations comprising:
determining a first route between a source and a destination;
dividing the first route into a plurality of segments;
determining, for the plurality of segments of the first route, at least two types of fuel usages for at least one transport medium of the first route to use while traversing along the segments of the first route; and
causing the at least one transport medium of the first route to adhere to the determined types of fuel usages traversing along the segments of the first route.

11. The computer program product of claim 10, wherein the at least one transport medium is selected from the group consisting of: a car, a truck, a plane, a boat, a drone, and a train.

12. The computer program product of claim 10, wherein the determining, for the segments of the first route, at least two types of fuel usages for the at least one transport medium to use while traversing along the segments of the first route comprises:
determining whether a first of the types of fuel usages satisfies a first predetermined factor applicable to transport mediums traversing a first of the segments of the first route;
in response to a determination that the first type of fuel usage satisfies the first predetermined factor, assigning the first type of fuel usage to be the type of fuel usage that is adhered to by transport mediums of the first route; and
in response to a determination that the first type of fuel usage does not satisfy the first predetermined factor, assigning a second of the types of fuel usages to be the type of fuel usage that is adhered to by transport mediums of the first route.

13. The computer program product of claim 12, wherein the predetermined first factor is selected from the group consisting of: cost, carbon present in the first segment, whether the first segment is an ecological endangered zone, and whether endangered animal species are present along the first segment.

14. The computer program product of claim 12, wherein the first type of fuel usage uses a petroleum-based internal combustion engine fuel, wherein the second type of fuel usage uses a fuel selected from the group consisting of: electricity from lithium ion batteries, compressed natural gas, liquefied natural gas, and hydrogen fuel cells.

15. The computer program product of claim 10, wherein the operations further comprise:
determining a second route between the source and the destination;
dividing the second route into a plurality of segments;
determining for the plurality of segments of the second route, at least two types of fuel usages for at least one transport medium of the second route to use while traversing along the segments of the second route;
comparing first carbon emissions that result from causing the at least one transport medium of the first route to adhere to the determined types of fuel usages traversing along the segments of the first route to second carbon emissions that result from causing the at least one transport medium of the second route to adhere to the determined types of fuel usages traversing along the segments of the second route;
identifying, from results of the comparison, which of the routes has relatively less resulting carbon emissions; and
causing a product to be transported from the source to the destination along the identified route, wherein the at least one transport medium of the identified route is caused to adhere to the determined types of fuel usages while traversing along the segments of the identified route to transport the product.

16. The computer program product of claim 10, wherein the causing the at least one transport medium of the first route to adhere to the determined types of fuel usages traversing along the segments of the first route comprises:
in response to a determination that a first transport medium, of the at least one transport medium of the first route, does not adhere to a first of the determined types of fuel usages while traversing along a first of the segments of the first route, assigning a penalty point to the first transport medium of the first route, wherein the operations further comprise:
outputting an indication of the assignment of the penalty point to a predetermined governing body.

17. The computer program product of claim 16, wherein the causing the at least one transport medium of the first route to adhere to the determined types of fuel usages traversing along the segments of the first route comprises:
determining whether a sum of penalty points assigned to the first transport medium of the first route exceeds a predetermined penalty point threshold,
in response to a determination that the sum of penalty points assigned to the first transport medium of the first route exceeds the predetermined penalty point threshold:
determining a second route between the source and the destination;
dividing the second route into a plurality of segments;
determining for the plurality of segments of the second route, at least two types of fuel usages for at least one transport medium of the second route to use while traversing along the segments of the second route; and
causing a product to be transported from the source to the destination along the second route, wherein the at least one transport medium of the second route adheres to the determined types of fuel usages for at least one transport medium of the second route while transporting the product along the segments of the second route, and
in response to a determination that the sum of penalty points assigned to the first transport medium of the first route does not exceed the predetermined penalty point threshold: causing the product to be transported from the source to the destination along the first route.

18. The computer program product of claim 10, wherein the operations further comprise:
obtaining data, the obtained data including data selected from the group consisting of:
geographic information system (GIS) data, geofencing library data, and historical carbon emission data; and
using the obtained data to create a hybrid fuel adoption map between the source and the destination, wherein the hybrid fuel adoption map details a plurality of routes between the source and the destination including the first route, wherein the hybrid fuel adoption map visually indicates the determined types of fuel usages of the routes.

19. A computer system comprising:
a processor set;
one or more computer-readable storage media; and
program instructions stored on the one or more storage media to cause the processor set to perform operations comprising:
determining a first route between a source and a destination;
dividing the first route into a plurality of segments;
determining, for the plurality of segments of the first route, at least two types of fuel usages for at least one transport medium of the first route to use while traversing along the segments of the first route; and
causing the at least one transport medium of the first route to adhere to the determined types of fuel usages traversing along the segments of the first route.

20. The computer system of claim 19, wherein the at least one transport medium is selected from the group consisting of: a car, a truck, a plane, a boat, a drone, and a train.
